(19) United States
(12) Patent Application Publication
(10) Pub. No.: US 2026/0226832 A1
(43) Pub. Date: Aug. 6, 2026

(54) SYSTEM AND METHOD FOR REGULATING NON-ENERGY-CONSUMING COMPLEX ENVIRONMENT IN MINE BASED ON COMPRESSED AIR ENERGY STORAGE

(71) Applicant: CHINA UNIVERSITY OF GEOSCIENCES (WUHAN), Wuhan (CN)

(72) Inventors: Guohua ZHANG, Wuhan (CN); Yu XU, Wuhan (CN); Yuyong JIAO, Wuhan (CN); Yuchen SUN, Wuhan (CN); Feng XIONG, Wuhan (CN); Dongjie HUA, Wuhan (CN); Fubin TU, Wuhan (CN); Junpeng ZOU, Wuhan (CN); Fei TAN, Wuhan (CN)

(73) Assignee: CHINA UNIVERSITY OF GEOSCIENCES (WUHAN), Wuhan (CN)

(21) Appl. No.: 19/636,960

(22) Filed: Apr. 2, 2026

(30) Foreign Application Priority Data
Dec. 3, 2025 (CN) 202511808216.5

(51) Int. Cl. E21F 1/08; F02C 1/02

(52) U.S. Cl. CPC E21F 1/085; F02C 1/02

(57) ABSTRACT

A system for regulating a non-energy-consuming complex environment in a mine based on compressed air energy storage, comprises: a compressed air energy storage power station; an air capturing and pressure stabilizing device; an air purifying device; a flow velocity and rate regulating device; and an intelligent decision-making and coordinated control system configured to: determine an air pressure within a valve seat according to a resistance change of a contact conductor; and compare the air pressure within the valve seat with a preset pressure value and control a driving mechanism to drive a valve core to move up and down according to a comparison result such that a pressure of air output by the air capturing and pressure stabilizing device is stabilized at the preset pressure value.

### CROSS-REFERENCE TO RELATED APPLICATIONS

This application claims priority to Chinese Patent Application No. 202511808216.5 with a filing date of Dec. 3, 2025. The content of the aforementioned application, including any intervening amendments thereto, is incorporated herein by reference.

### TECHNICAL FIELD

The present disclosure relates to the technical field of environmental regulation in mines, and in particular, to a system and method for regulating a non-energy-consuming complex environment in a mine based on compressed air energy storage.

### BACKGROUND

In the context of deep mining operations for underground mines such as coal, iron, and copper mines, the working faces require substantial volumes of fresh air to eliminate dust, harmful gases, and the like within the mines, as well as to reduce temperatures therein. Moreover, to ensure air quality within the mines and facilitate smoke removal, dust control, and dilution of harmful gases, a continuous supply of substantial volumes of fresh air is essential. Currently, underground mining operations rely entirely on mechanical refrigeration, physical cooling, and passive ventilation measures to address these problems. However, these cooling and ventilation measures present problems such as structural complexity, high costs, and occupation of underground mining space. Additionally, mechanical refrigeration, physical cooling, and passive ventilation systems consume significant amounts of power and suffer from substantial energy losses. Therefore, achieving both ventilation (pollutant removal) and cooling (heat extraction) in an economical and efficient manner has become a technical challenge urgently needing to be addressed in environmental regulation for deep mining operations.

Meanwhile, with the rapid advancement of renewable energy sources such as wind and solar power, compressed air energy storage has been widely adopted as a large-scale physical energy storage technology. Compressed air energy storage is a novel physical energy storage technology that utilizes compressed air as an energy carrier for storing and converting energy. It converts surplus electricity from wind and solar power into high-pressure air, which is stored in an underground air storage reservoir. When electricity is needed, the high-pressure air is released from the underground air storage reservoir to drive a turbine unit to rotate for power generation. This technology serves as an effective means of mitigating fluctuations in clean energy grid integration and balancing power supply and demand. The underground air storage reservoir, as the core of a compressed air energy storage system, can be constructed in an abandoned or idle mine within a deep mining area, enabling the secondary exploitation and utilization of the abandoned mine for repurposing abandoned mine resources and reducing the construction cost of the underground air storage reservoir. After releasing high-pressure air to drive the turbine unit to generate power, the underground air storage reservoir discharges a substantial volume of low-temperature air (10-20° C.) at a high flow rate (50-350 kg/s) and a high velocity (20-35 m/s). Currently, these high-quality, high-flow-rate, and high-flow-velocity cold sources are directly released into the atmosphere, resulting in significant energy waste.

In view of the above-mentioned technical status, there is notable potential for synergistic application between the low-temperature, high-flow-rate air discharged by the compressed air energy storage system and the ventilation and cooling requirements of a deep mine. At present, there is an urgent need to develop a specialized technical equipment and system tailored to the exhaust characteristics of turbine units of compressed air energy storage power stations so as to replace traditional high-energy-consumption ventilation and cooling methods, enabling mine ventilation and cooling integrated environmental regulation.

### SUMMARY OF PRESENT INVENTION

In view of the above, to overcome shortcomings of the prior art regarding the supply of fresh air in underground mines during deep mining operations, embodiments of the present disclosure provide a system and method for regulating a non-energy-consuming complex environment in a mine based on compressed air energy storage.

An embodiment of the present disclosure provides a system for regulating a non-energy-consuming complex environment in a mine based on compressed air energy storage, comprising a compressed air energy storage power station, an air capturing and pressure stabilizing device, an air purifying device, and a flow velocity and rate regulating device, and an intelligent decision-making and coordinated control system;

Wherein the compressed air energy storage power station is constructed in an operating mine that is provided with an underground mining cavern; the compressed air energy storage power station includes a turbine unit that is provided with an air delivery pipe for discharging air produced by energy release for power generation;

An air inlet of the air capturing and pressure stabilizing device is disposed within the air delivery pipe; the air capturing and pressure stabilizing device comprises a valve seat, a valve core, a pressure monitoring assembly, and a driving mechanism, wherein an air inlet and an air outlet are provided at upper and lower ends of the valve seat, respectively; the air inlet is tapered; the valve core includes three layers of umbrella-shaped valve discs spaced apart along a vertical direction; the pressure monitoring assembly is arranged inside the valve seat and includes a monitoring chamber, a diaphragm, an elastic piece, a pressure pointer, and a contact conductor; the monitoring chamber has an upper portion provided with a detection opening and an interior provided with the diaphragm; the interior of the monitoring chamber is divided by the diaphragm into an upper air cavity and a lower air cavity; the elastic piece is vertically arranged and connected to the diaphragm; the pressure pointer is connected to the elastic piece; the contact conductor is vertically and fixedly arranged on a side of the pressure pointer; the pressure pointer is in vertically sliding contact with the contact conductor such that the pressure pointer and the contact conductor form a sliding rheostat structure; and the driving mechanism is connected to the valve core to drive the valve core to move up and down;

The air purifying device is connected to the air outlet of the valve seat, and includes a multi-stage filter unit, a gas humidity regulation unit, and an ultraviolet sterilization unit that are connected in sequence;

The flow velocity and rate regulating device is connected to the air purifying device and the underground mining cavern; and

The intelligent decision-making and coordinated control system is connected to the air capturing and pressure stabilizing device, the air purifying device, the flow velocity and rate regulating device, and environmental sensors distributed within pipes and the underground mining cavern, and is configured to: receive a real-time pressure signal from the pressure monitoring assembly, a flow rate feedback value from the flow velocity and rate regulating device, and temperature, humidity, and gas and dust concentration data from the environmental sensors within the underground mining cavern; calculate, using a multi-objective optimization algorithm, a preset pressure and a target flow velocity and rate meeting environmental requirements of the underground mining cavern; and issue execution instructions to the air capturing and pressure stabilizing device, the air purifying device, and the flow velocity and rate regulating device, enabling precise control of the pressure and the flow velocity and rate of air input to the underground mining cavern.

Further, the elastic piece is a spring; the contact conductor is arranged in parallel with the spring; the pressure pointer has one end perpendicularly connected to the spring and the other end in sliding contact with the contact conductor; an air pressure change within the monitoring chamber pushes the diaphragm to drive the elastic piece to expand and contract, thereby driving the pressure pointer to produce a vertical sliding displacement relative to the contact conductor, such that the pressure pointer and the contact conductor form the sliding rheostat structure, thereby allowing the real-time pressure signal to be output to the intelligent decision-making and coordinated control system.

Further, the driving mechanism is a hydraulic cylinder that is arranged vertically and has a bottom fixed to the air outlet of the valve seat via a holder; and an output end of the hydraulic cylinder is arranged upwards and connected to a lower end of the valve core.

Further, flexible sealing rings are disposed at edges of the valve discs; and the three layers of valve discs have gradually increasing diameters from top to bottom, wherein upper two of the three layers of valve discs are configured for contact with and separation from an inner wall of the air inlet to control air introduction, while a lower one of the three layers of valve discs is configured for contact with the inner wall of the air inlet and is sealed by the flexible sealing ring to prevent air backflow.

Further, the flow velocity and rate regulating device includes a ball valve housing, a ball, and a servo motor; upper and lower ends of the ball valve housing are open; the ball is provided with a shaft hole extending therethrough, and is rotatably arranged within the ball valve housing and connected to the servo motor; and the upper end of the ball valve housing is connected to the air purifying device, while the lower end of the ball valve housing is connected to the underground mining cavern.

Further, the flow velocity and rate regulating device further includes a flow velocity and rate sensor that is arranged at the lower end of the ball valve housing; and the intelligent decision-making and coordinated control system is connected to the flow velocity and rate sensor and the servo motor, and is configured to control, according to the flow velocity and rate of air detected by the flow velocity and rate sensor, the servo motor to drive the ball to rotate, thereby adjusting opening degrees of the upper and lower ends of the ball valve housing.

Further, the environmental sensors within the underground mining cavern are configured to detect a temperature, a humidity, a gas concentration, and a dust concentration within the underground mining cavern, and feed signals back to the intelligent decision-making and coordinated control system.

Further, the compressed air energy storage power station further includes a wind power generation device, a photovoltaic power generation array, and a compressor unit that are arranged on the ground of the operating mine, and an air storage reservoir that is arranged under the ground of the operating mine; the wind power generation device and the photovoltaic power generation array are connected to the compressor unit to supply power to the compressor unit; the compressor unit is connected to the air storage reservoir such that air is compressed to a predetermined pressure and then stored in the air storage reservoir; and the air storage reservoir is connected to the turbine unit so as to input high-pressure air to the turbine unit such that the turbine unit does work through expansion for power generation, thereby producing air.

Furthermore, an embodiment of the present disclosure further provides a method for regulating a non-energy-consuming complex environment in a mine based on compressed air energy storage, applied to the system for regulating a non-energy-consuming complex environment in a mine based on compressed air energy storage described above and including the following steps:
S1, outputting air produced by the turbine unit expanding the high-pressure air to drive the turbine unit to generate power along the air delivery pipe;
S2, calculating, by the intelligent decision-making and coordinated control system, a preset pressure and a target flow velocity and rate meeting environmental requirements of the underground mining cavern using a multi-objective optimization algorithm based on received environmental parameters;
S3, capturing, by the air capturing and pressure stabilizing device, part of the air output by the air delivery pipe using the kinetic energy of the air discharged by the turbine unit, and adjusting a pressure of the captured air according to the preset pressure calculated in step S2 so as to output air under a preset constant pressure;
S4, filtering and purifying, by the air purifying device, the air output by the air capturing and pressure stabilizing device; and
S5, adjusting, by the flow velocity and rate regulating device, a flow velocity and rate of the air filtered and purified by the air purifying device according to the target flow velocity and rate calculated in step S2, and outputting air with the target flow velocity and rate to the underground mining cavern.

The technical solution provided in the present disclosure has the beneficial effects:
1. The present disclosure provides a system and method for regulating a non-energy-consuming complex environment in a mine based on compressed air energy storage, where the low-temperature, high-flow-rate, and high-flow-velocity air produced from power generation by the turbine unit is captured by the air capturing and pressure stabilizing device in an active and non-power-consuming manner, and filtered and purified by the air purifying device and then adjusted in flow velocity and rate before being introduced into the underground mining cavern; and therefore, a desired substantial volume of fresh air and cooling capacity can be supplied to the underground mining cavern, thereby replacing traditional ventilation and cooling methods to achieve environmental parameter regulation of ventilation and temperature in the underground mining cavern. Based on this, an organic integration of compressed air energy storage and environmental regulation of the underground mining cavern is realized. This ultimately significantly reduces energy consumption for mine environment regulation and reduces mine operating costs.
2. The present disclosure provides a system and method for regulating a non-energy-consuming complex environment in a mine based on compressed air energy storage, where power generation through compressed air energy storage is organically integrated with the environmental regulation of the underground mining cavern, achieving gradient utilization of the cooling capacity discharged from the turbine unit and improving the comprehensive energy efficiency of the compressed air energy storage system. Simultaneously, the air storage reservoir is constructed in the abandoned mine, thereby enabling the reuse of abandoned mine resources and reducing the construction investment for the air storage reservoir.
3. The present disclosure provides a system and method for regulating a non-energy-consuming complex environment in a mine based on compressed air energy storage, where the air capturing and pressure stabilizing device captures a portion of the required airflow from the air delivery pipe of the turbine unit; by utilizing the kinetic energy of the airflow discharged from the air delivery pipe without requiring additional power, non-power-consuming capture is achieved. Furthermore, the pressure monitoring assembly cooperates with the driving mechanism to keep the valve core dynamically and stably positioned as required for pressure balance. Thus, the function of providing constant-pressure air downstream is realized, thereby meeting the safe working condition requirements of downstream equipment and the demand for fresh air and cooling capacity in the underground mining cavern. Particularly, the present disclosure achieves incremental opening by utilizing the plurality of layers of valve discs. Compared to a traditional single valve core, this allows for more linear flow rate adjustment and effectively eliminates vibration of the valve core caused by high-pressure airflow, thereby significantly improving the operational stability of the device under high-pressure working conditions.
4. The present disclosure provides a system and method for regulating a non-energy-consuming complex environment in a mine based on compressed air energy storage, where by providing a professional multi-stage air purifying device, it is ensured that the air introduced into the underground mining cavern meets cleanliness and safety standards concerning particulate matter, oil contamination, humidity, and microorganisms, thereby safeguarding worker health; and by providing the multi-parameter coordinated control logic and coordinated control system, “on-demand air supply and precise cooling” are achieved, offering higher reliability and requiring less maintenance compared to traditional equipment.

### BRIEF DESCRIPTION OF THE DRAWINGS

FIG. 1 is a schematic diagram showing a system for regulating a non-energy-consuming complex environment in a mine based on compressed air energy storage according to an embodiment of the present disclosure;

FIG. 2 is a workflow diagram showing a system for regulating a non-energy-consuming complex environment in a mine based on compressed air energy storage according to an embodiment of the present disclosure;

FIG. 3 is a diagram showing an air flow pipeline of a system for regulating a non-energy-consuming complex environment in a mine based on compressed air energy storage according to an embodiment of the present disclosure;

FIG. 4 is a schematic diagram showing states of an air capturing and pressure stabilizing device, where (a) shows a flow state, and (b) shows a cut-off state;

FIG. 5 is a sectional view showing an air capturing and pressure stabilizing device, where (a) shows a flow state, and (b) shows a cut-off state;

FIG. 6 is a schematic diagram showing a pressure monitoring assembly;

FIG. 7 is a schematic diagram showing a flow velocity and rate regulating device where (a) shows a state in a maximum flow velocity and rate, and (b) shows a state in a minimum flow velocity and rate; and

FIG. 8 is a control schematic diagram of a system for regulating a non-energy-consuming complex environment in a mine based on compressed air energy storage according to the present disclosure.

List of Reference Numerals: 1-air storage reservoir; 2-turbine unit; 3-air capturing and pressure stabilizing device; 4-compressor unit; 5-expanded air discharge facility; 6-dispatching and operation center; 7-wind power generation device; 8-photovoltaic power generation array; 9-power grid; 10-underground mining cavern; 12-high-pressure air input pipe; 13-air delivery pipe; 14-air capturing pipe; 15-air inlet; 16-pressure monitoring assembly; 17-pressure relief valve; 18-air purifying device; 19-flow velocity and rate sensor; 20-intelligent decision-making and coordinated control system; 21-flow velocity and rate regulating device; 22-flange; 23-valve seat; 24-sealing ring; 25-valve core; 26-output end; 27-detection opening; 28-driving mechanism; 29-holder; 30-air outlet; 31-housing; 32-hydraulic cylinder; 33-upper air cavity; 34-diaphragm; 35-lower air cavity; 36-elastic piece; 37-pressure pointer; 38-contact conductor; 39-ball; 40-servo motor; 41-bearing; 42-humidity sensor; 43-ball valve housing; 44-environmental sensor; 45-gas concentration detection sensor; and 46-pressure sensor.

### DETAILED DESCRIPTION OF THE EMBODIMENTS

In order to make the objective, technical solution, and advantages of the present disclosure clearer, the embodiments of the present disclosure will be further described in detail in conjunction with the accompanying drawings. The following describes a preferred one of a number of possible embodiments of the present disclosure, and is intended to provide a basic understanding of the present disclosure, but is not intended to identify key or critical elements of the present disclosure or to define the scope of protection.

In all examples shown and discussed herein, any specific value should be interpreted as merely exemplary, rather than restrictive. Therefore, others examples of the exemplary embodiments may have different values.

Techniques, methods and devices known to those of ordinary skill in the related art may not be discussed in detail, but where appropriate, the techniques, methods and devices should be considered as part of the description.

It should be noted that similar reference numerals and letters represent similar items in the accompanying drawings below. Therefore, once an item is defined in one figure, it does not need to be further defined and described in subsequent figures. Meanwhile, it should be understood that for ease of description, each portion in the accompanying drawings is not necessarily drawn to the actual scale.

It should be noted that, unless otherwise clearly specified, meanings of terms “provided”, “connected with”, and “connected to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. A person of ordinary skill in the art may understand specific meanings of the foregoing terms in the present disclosure based on a specific situation.

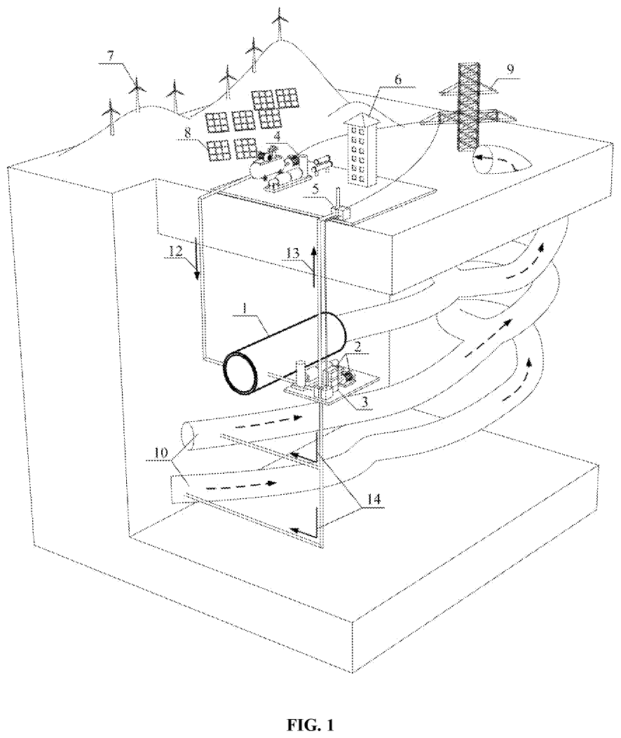

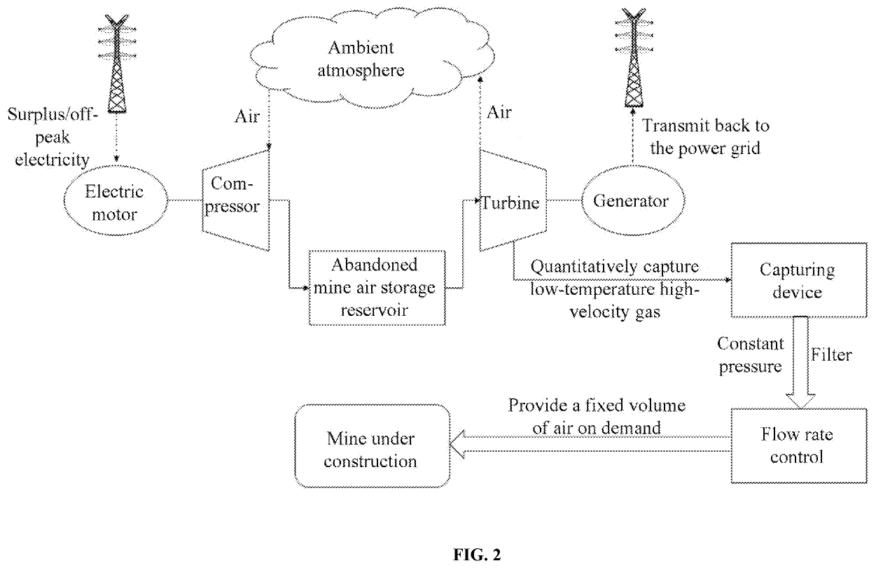

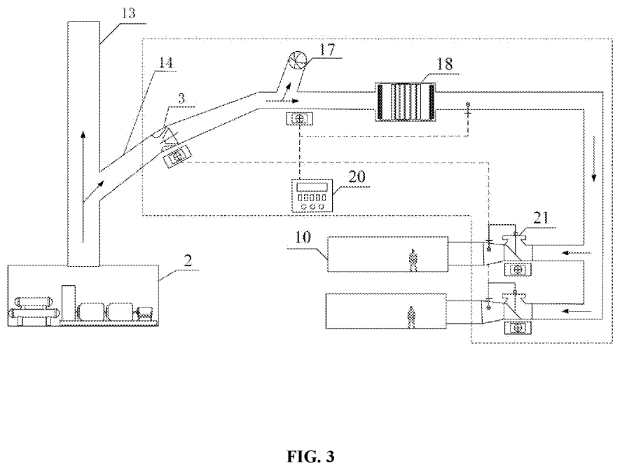

Referring to FIG. 1, FIG. 2, and FIG. 3, an embodiment of the present disclosure provides a system for regulating a non-energy-consuming complex environment in a mine based on compressed air energy storage, including a compressed air energy storage (CAES) power station, an air capturing and pressure stabilizing device 3, an air purifying device 18, a flow velocity and rate regulating device 21, and an intelligent decision-making and coordinated control system 20.

The CAES power station is constructed in an operating mine that is provided with an underground mining cavern 10. The CAES power station comprises a turbine unit 2 that is provided with an air delivery pipe 13 for discharging air produced by energy release for power generation.

Specifically, the CAES power station is generally constructed by utilizing the idle land of the operating mine and the underground mining cavern 10. Generally, the CAES power station further includes a wind power generation device 7, a photovoltaic power generation array 8, and a compressor unit 4 that are arranged on the ground of the operating mine, and an air storage reservoir 1 that is arranged under the ground of the operating mine. The wind power generation device 7 and the photovoltaic power generation array 8 are connected to the compressor unit 4 to supply power to the compressor unit 4. The wind power generation device 7 and the photovoltaic power generation array 8 constitute a ground power generation system. The power generated by the ground power generation system at ordinary times is integrated into a commercial power grid 9, and the power that cannot be absorbed by the commercial power grid 9 is supplied to the compressor unit 4 on the ground.

The compressor unit 4 is connected to the air storage reservoir 1 such that air is compressed to a predetermined pressure and then delivered through a high-pressure air input pipe 12 to the air storage reservoir 1 for storage. When the wind power generation device 7 and the photovoltaic power generation array 8 have surplus power in addition to the power supplied to the commercial power grid 9, the power is transmitted to drive the compressor to compress air to the predetermined pressure. The compressed high-pressure air is then delivered through an injection pipe to an underground air storage reservoir 1, achieving energy storage of surplus power resources.

The air storage reservoir 1 is connected to the turbine unit 2 so as to input high-pressure air to the turbine unit 2 such that the turbine unit 2 does work through expansion for power generation, thereby producing air. During peak nighttime power demand period, when the CAES enters the energy release phase, the high-pressure air enters the turbine unit 2 from the air storage reservoir 1 to expand and do work, driving a generator to output electrical energy. The electrical energy is transmitted via cables to the ground commercial power grid 9, achieving energy release for power generation. As described here, the air produced from power generation by the turbine unit 2 doing work through expansion is characterized by low temperature (10-20° C.), high flow rate (50-350 kg/s), and high flow velocity (20-35 m/s). A dispatching and operation center 6 of the CAES power station can automatically dispatch the system based on the load of the power grid 9 and environmental monitoring signals, enabling intelligent management of the energy storage and release processes.

The air capturing and pressure stabilizing device 3 is connected to the air delivery pipe 13 via an air capturing pipe 14. The low-temperature, high-flow-rate, and high-flow-velocity air discharged from the turbine unit 2 is delivered outward along the air delivery pipe 13 to an expanded air discharge facility 5. The air capturing pipe 14 is connected to the middle of the air delivery pipe 13 to divert the air from the air delivery pipe 13.

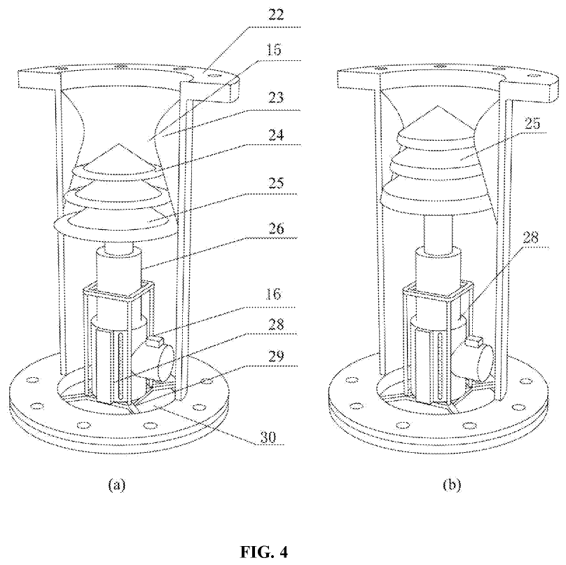

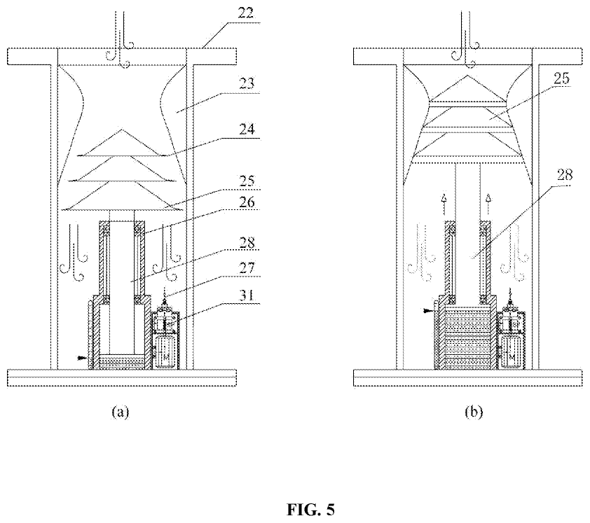

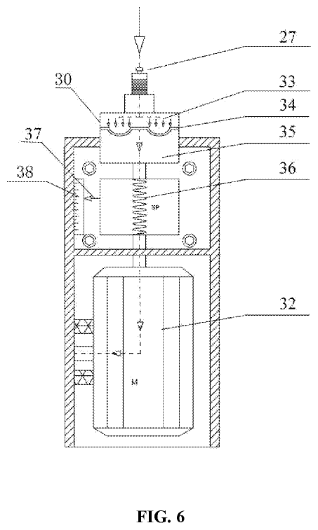

Referring to FIG. 4, FIG. 5, and FIG. 6, the air capturing and pressure stabilizing device 3 includes a valve seat 23, a valve core 25, a pressure monitoring assembly 16, and a driving mechanism 28, wherein an air inlet 15 and an air outlet 30 are provided at upper and lower ends of the valve seat 23, respectively. The air inlet 15 is tapered. The valve core 25 includes three layers of umbrella-shaped valve discs spaced apart along a vertical direction. Here, flanges 22 are disposed at both upper and lower ends of the valve seat 23, such that the valve seat is connected to the air capturing pipe and the air purifying device 18 via the flanges 22, respectively. A shape of the sidewall of the valve core 25 is fit with that of the inner wall of the air inlet 15. Thus, the valve core can fit against the inner wall of the air inlet 15 to seal the air inlet 15. To snugly fit the valve core 25 against the inner wall of the air inlet 15, a sealing ring 24 is disposed at the edge of the valve disc. The valve core 25 can be hermetically connected to the air inlet 15 by pressing the sealing ring 24.

The pressure monitoring assembly 16 is arranged within a housing 31 inside the valve seat 23, and in particular, below the valve core 25. The pressure monitoring assembly 16 includes a monitoring chamber, a diaphragm 34, an elastic piece 36, a pressure pointer 37, and a contact conductor 38. The monitoring chamber has an upper portion provided with a detection opening 27 and an interior provided with the diaphragm 34. The detection opening 27 allows the air within the valve seat 23 to enter. The interior of the monitoring chamber is divided by the diaphragm 34 into an upper air cavity 33 and a lower air cavity 35. The elastic piece 36 is vertically arranged and connected to the diaphragm 34. Here, the upper end of the elastic piece 36 is connected to the diaphragm 34 via a sliding shaft capable of sliding vertically. The pressure pointer 37 is connected to the elastic piece 36. The contact conductor 38 is vertically and fixedly arranged on a side of the pressure pointer 37. The pressure pointer 37 is a conductor. The pressure pointer 37 is in vertically sliding contact with the contact conductor 38 such that the pressure pointer 37 and the contact conductor 38 form a sliding rheostat structure. The driving mechanism 28 is connected to the valve core 25 to drive the valve core 25 to move up and down. The air within the valve seat 23 enters the monitoring chamber from the detection opening 27. The air presses the diaphragm 34 such that the diaphragm 34 drives the elastic piece 36 to expand and contract, thereby causing the pressure pointer 37 to be in sliding contact with the contact conductor 38. Thus, a contact position can be changed.

The number of valve discs may be set flexibly according to the requirements for air introduction in practical applications. As an example, the valve core 25 in this embodiment includes three layers of valve discs that have gradually increasing diameters from top to bottom, wherein upper two of the three layers of valve discs are configured for contact with and separation from the inner wall of the air inlet 15 to control air introduction, while a lower one of the three layers of valve discs is configured for contact with the inner wall of the air inlet 15 to prevent air backflow. With such a multi-layer valve disc structure, incremental opening can be achieved, thereby allowing for more linear flow rate adjustment and reducing the impact and vibration caused by high-pressure airflow on the valve core. Compared to an ordinary single valve core structure, this structure results in more stable operation and a longer service life.

In some embodiments, the elastic piece 36 is a spring. The contact conductor 38 is arranged in parallel with the spring. The pressure pointer 37 has one end perpendicularly connected to the spring and the other end in sliding contact with the contact conductor 38.

In some embodiments, the driving mechanism 28 is a hydraulic cylinder 32 that is arranged vertically and has a bottom fixed to the air outlet 30 of the valve seat 23 via a holder 29. An output end 26 of the hydraulic cylinder 32 is arranged upwards and connected to a lower end of the valve core 25.

The air purifying device 18 is connected to the air outlet 30 of the valve seat 23 via a pipe. A pressure relief valve 17 may further be disposed between the air purifying device 18 and the air capturing and pressure stabilizing device 3 to release pressure.

Since the air output from the air capturing and pressure stabilizing device 3 originates from a plurality of compression-expansion working medium cycles, it tends to entrain lubricating oil vapor, metal wear particles, and condensate water formed due to temperature changes. If this airflow is introduced directly into the underground mining cavern 10, far from improving the environment, it would instead introduce new pollutants (oil mist, and sources of microbial growth), exacerbating equipment corrosion and health risks. Therefore, the air purifying device 18 is provided here to filter and purify the air, such that dust, moisture, and microorganisms entrained in high-pressure air during the compression and release processes are progressively removed at this phase.

Specifically, the air purifying device 18 comprises a multi-stage filter unit, a gas humidity regulation unit, and an ultraviolet sterilization unit that are connected in sequence.

A three-stage filter unit is employed as the multi-stage filter unit for air purification. At the first stage, a detachable and cleanable stainless steel filter screen is employed, which is regularly removed and cleaned and configured for primary filtration to primarily intercept large particles with a diameter greater than 5 microns, such as rust scale from pipes and dust, thereby protecting subsequent precision filter elements. At the second stage, a high-performance activated carbon filter element is employed, which is replaced regularly. Activated carbon, with its large specific surface area and abundant microporous structure, can effectively adsorb trace amounts of lubricating oil vapor and other odor molecules that may be entrained in the exhaust from the turbine unit 2. At the third stage, a high-efficiency particulate air (HEPA) filter element is employed, which has an interception efficiency of no less than 99.97% for particles with a diameter ≥0.3 μm (including fine metal wear particles, dust, etc.), ensuring that the air delivered to the underground mining cavern 10 meets cleanliness requirements in terms of particle concentration.

The gas humidity regulation unit is configured to regulate the humidity of the air output from the multi-stage filter unit, such that the humidity of the air delivered to the underground mining cavern 10 is maintained within a comfortable range of 40%-60%. The gas humidity regulation unit includes a three-way proportional regulating valve, as well as a dehumidification branch and a humidification branch that are connected to the three-way proportional regulating valve. By dynamically adjusting the proportion of airflow entering the dehumidification branch, the deeply dehumidified dry air is precisely mixed with the untreated humid air, thereby achieving continuous and stable control of the humidity of the final air from the air outlet. Before the final mixed air is delivered, it flows through a high-accuracy humidity sensor. This sensor is configured to monitor the humidity value of the air at the air outlet in real time and adjust the proportion of the dehumidification branch in real time based on the detected humidity value. If the humidity exceeds an upper limit, the proportion of the dehumidification branch is increased to increase the amount of dry air mixed. If the humidity falls below a lower limit, the proportion of the dehumidification branch is reduced to increase the final humidity.

The dehumidification branch employs a mechanical air-water separator for dehumidification. The mechanical air-water separator utilizes the physical principles of gravity settling and centrifugal force. Air enters tangentially into a cyclone separation cavity. During high-speed rotation, water droplets with higher density are thrown toward the walls by inertia and slide down along the walls into a bottom collection tank, thereby achieving preliminary air-liquid separation. Subsequently, the airflow passes through a module equipped with a high-efficiency demister (e.g., a wire mesh mist eliminator) to further intercept fine droplets.

The ultraviolet sterilization unit is configured to remove microorganisms (such as bacteria, viruses, and mold spores) from the air. The ultraviolet sterilization unit employs ultraviolet sterilization technology, specifically short-wave ultraviolet light in the UV-C band, which can damage the DNA and RNA of microorganisms, rendering them inactivated or dead. The sterilization effect of this sterilization technology depends on the ultraviolet irradiation dose, which can ensure a stable effect. As an example, the ultraviolet sterilization unit in this embodiment is a low-pressure mercury lamp or a high-efficiency ultraviolet light-emitting diode (LED), and the channel design of this unit is optimized (the internal channel is made of a material with high reflectivity, allowing the ultraviolet light to reflect a plurality of times within the cavity, thereby prolonging the irradiation time). Airflow equalizing plates are disposed at both the air inlet and outlet of this unit to ensure that air flows uniformly through the ultraviolet irradiation area.

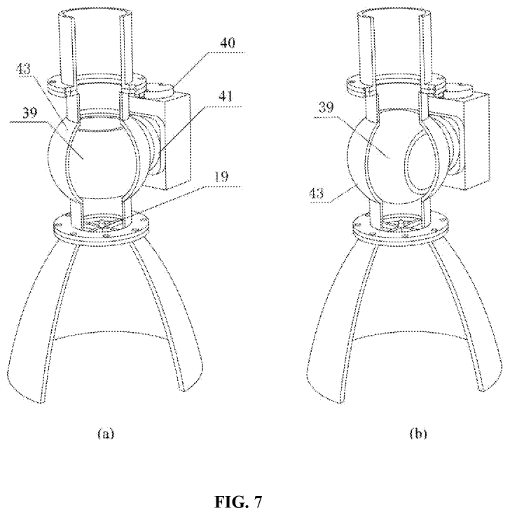

Referring to FIG. 7, the flow velocity and rate regulating device 21 is connected to the air purifying device 18 and the underground mining cavern 10 via pipes. The flow velocity and rate regulating device 21 is configured to reduce the high flow velocity (20-35 m/s) of the air output from the air purifying device 18 to a migration velocity (typically 0.25-4 m/s) suitable for underground mining caverns that complies with mine safety regulations, and achieve quantitative air supply. This effectively avoids problems such as secondary dust entrainment caused by excessively high air velocities, reduced equipment stability, and personnel discomfort.

Specifically, the flow velocity and rate regulating device 21 includes a ball valve housing 43, a ball 39, and a servo motor 40. Upper and lower ends of the ball valve housing 43 are open. The ball 39 is provided with a shaft hole extending therethrough, and is rotatably arranged within the ball valve housing 43 and connected to the servo motor 40. Here, the servo motor 40 is mounted on the ball valve housing 43 and connected to the ball 39 via a bearing 41. The ball valve housing 43 has the upper end connected to the air purifying device 18 and the lower end connected to the underground mining cavern 10. The servo motor 40 is configured to drive the ball 39 to rotate, so that the shaft hole is aligned or misaligned with the openings at the upper and lower ends of the ball valve housing 43, thereby adjusting the opening degrees of the upper and lower openings of the ball valve housing 43.

The flow velocity and rate regulating device 21 further includes a flow velocity and rate sensor 19. The flow velocity and rate sensor 19 includes an air velocity sensor and a differential pressure flowmeter. The flow velocity and rate sensor 19 is arranged at the lower end of the ball valve housing 43. The intelligent decision-making and coordinated control system 20 is connected to the flow velocity and rate sensor 19 and the servo motor 40, and is configured to control, according to the flow velocity and rate of air detected by the flow velocity and rate sensor 19, the servo motor 40 to drive the ball 39 to rotate, thereby adjusting the opening degrees of the upper and lower ends of the ball valve housing 43.

The intelligent decision-making and coordinated control system 20 is connected to the air capturing and pressure stabilizing device 3, the air purifying device 18, the flow velocity and rate regulating device 21, and environmental sensors distributed within pipes and the underground mining cavern, and is configured to: receive a real-time pressure signal from the pressure monitoring assembly, a flow rate feedback value from the flow velocity and rate regulating device 21, and temperature, humidity, and gas and dust concentration data from the environmental sensors within the underground mining cavern; calculate, using a multi-objective optimization algorithm, a preset pressure and a target flow velocity and rate meeting environmental requirements of the underground mining cavern; and issue execution instructions to the air capturing and pressure stabilizing device 3, the air purifying device 18, and the flow velocity and rate regulating device 21, enabling precise control of the pressure and the flow velocity and rate of air input to the underground mining cavern.

Specifically, the pressure of the air fed into the underground mining cavern is controlled. The intelligent decision-making and coordinated control system 20 is connected to the contact conductor 38 and the driving mechanism 28 and is configured to determine the air pressure within the valve seat 23 based on the resistance change of the contact conductor 38. The change in the contact position between the pressure pointer 37 and the contact conductor 38 alters the connection resistance of the contact conductor 38, thereby enabling the detection of the air pressure within the valve seat 23. The intelligent decision-making and coordinated control system 20 is configured to compare the air pressure within the valve seat 23 with a preset constant pressure value and control the driving mechanism 28 to drive the valve core 25 to move up and down based on a comparison result such that the pressure of air output by the air capturing and pressure stabilizing device 3 is stabilized at the preset constant pressure value.

The preset constant pressure value is generally 0.8-1.2 MPa. As an example, the preset constant pressure value in this embodiment is 1 MPa. The air pressure within the valve seat 23 represents the pressure of the air delivered downstream. Alternatively, a pressure sensor 46 may be arranged on a pipe downstream of the air capturing and pressure stabilizing device 3 to detect the downstream air pressure. If the downstream air pressure falls below the preset constant pressure value (for example, due to pressure fluctuations in the exhaust from the turbine unit 2 or increased downstream air demand causing a pressure drop in the pipeline), the intelligent decision-making and coordinated control system 20 controls the driving mechanism 28 to drive the valve core 25 to move down, thereby increasing the opening degree of the valve core 25 relative to the air inlet 15 for enlarging the flow area and capturing more airflow and rapidly raising the downstream air pressure back to the preset constant pressure value. If the downstream air pressure rises above the preset constant pressure value (for example, due to pressure fluctuations in the exhaust from the turbine unit 2 or reduced downstream exhaust demand causing a pressure increase in the pipeline), the intelligent decision-making and coordinated control system 20 will immediately control the driving mechanism 28 to drive the valve core 25 to move up, thereby decreasing the opening degree of the valve core 25 relative to the air inlet 15 for reducing the flow area and capturing less airflow and bringing the downstream air pressure down to the preset constant pressure value.

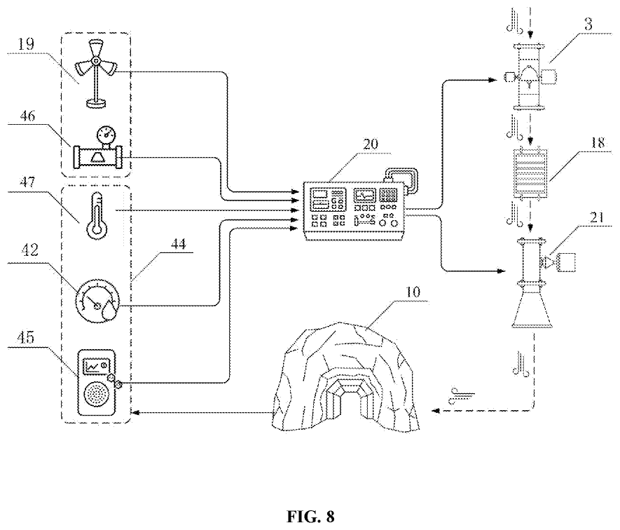

Referring to FIG. 8, the flow rate feedback value from the flow velocity and rate regulating device 21 is obtained by the flow velocity and rate sensor 19. The flow velocity and rate sensor 19 is configured to detect the flow velocity and rate of the air output from the lower end of the ball valve housing 43, and also monitor in real time the actual velocity and volume of the air delivered to the underground mining cavern 10. Compared with the air velocity and air volume required for air supply in the underground mining cavern 10, when a deviation between the actual flow rate value and the preset target flow rate for the system is detected, if an increase in flow rate is required, the servo motor 40 of the intelligent decision-making and coordinated control system 20 drives the ball 39 to rotate, such that the shaft hole of the ball 39 is aligned with upper and lower open tubes of the ball valve housing 43 or the included angle therebetween is reduced, thereby increasing the cross-sectional area of the flow channel and enhancing the flow rate. If a reduction or cutoff of flow is required, the servo motor 40 is controlled to drive the ball 39 to rotate, thereby enlarging the shaft hole and the upper and lower openings of the ball valve housing 43 and restricting airflow. The cross-sectional area of the flow channel decreases until it is completely closed, and the flow rate correspondingly decreases to zero.

During the operation of the system for regulating a non-energy-consuming complex environment in a mine based on compressed air energy storage in the present disclosure, the intelligent decision-making and coordinated control system 20 compares the real-time monitored air pressure, flow velocity and rate data with preset safe and comfort thresholds, and runs a built-in control algorithm to comprehensively generate an optimized control strategy. The intelligent decision-making and coordinated control system 20 controls the total inlet air pressure by adjusting the opening degree of the air capturing and pressure stabilizing device 3, and precisely controls the flow rate of the air input to the underground mining cavern 10 by adjusting the opening degree of the flow velocity and rate regulating device 21. The two components work in coordination to dynamically adjust the total volume and flow velocity of gas delivered into the underground mining cavern 10.

Specifically, the multi-objective optimization algorithm executed by the coordinated control system 20 comprises a hierarchical rule-based control logic that translates environmental inputs into physical hardware actuations. The algorithm prioritizes parameters in the following order: safety (gas and dust concentration), environmental comfort (temperature and humidity), and system pressure stability.
(1) Safety Priority Mode: The system continuously monitors the gas concentration and dust concentration within the underground mine workings. If the gas concentration or dust concentration exceeds a pre-programmed safety threshold, the algorithm overrides other objectives and outputs a maximum allowable target flow velocity. The control system 20 then transmits a command to the servo motor 40 to rotate the spherical valve element 39 to a fully aligned position, thereby maximizing the cross-sectional flow area to rapidly dilute the hazardous substances.
(2) Environmental Regulation Mode: When gas and dust levels are within safe limits, the algorithm optimizes for cooling and ventilation. The control system calculates a temperature differential between the real-time temperature detected by the environmental sensors 44 and a target comfortable temperature. Based on this differential, the algorithm calculates a required proportional target flow rate. Concurrently, the humidity data regulates the three-way proportional valve in the gas humidity regulation unit to maintain humidity between 40% and 60%.
(3) Dynamic Pressure Decoupling: To prevent the downstream flow rate adjustments from causing pressure fluctuations in the upstream devices, the algorithm runs an independent, continuous feedback loop for pressure stabilization. The control system 20 reads the resistance value from the potentiometer structure (the pressure pointer 37 and conductive contact 38). If the derived real-time pressure deviates from the preset constant pressure (e.g., 1 MPa), the control system instantly commands the hydraulic cylinder 32 to adjust the vertical position of the valve core 25. This dynamic decoupling ensures that the target flow velocity provided to the mine is purely a function of environmental demand, unaffected by the highly variable exhaust pressure of the turbine unit.

Furthermore, an embodiment of the present disclosure further provides a method for regulating a non-energy-consuming complex environment in a mine based on compressed air energy storage, applied to the system for regulating a non-energy-consuming complex environment in a mine based on compressed air energy storage described above and including the following steps.

In step S1, air produced by the turbine unit 2 expanding the high-pressure air to drive the turbine unit to generate power is output along the air delivery pipe 13.

The high-pressure air in the air storage reservoir 1 is input into the turbine unit 2. The turbine unit 2 does work through expansion for power generation and outputs, via the air delivery pipe 13, the low-temperature, high-flow-rate, and high-flow-velocity air produced from power generation.

In step S2, the intelligent decision-making and coordinated control system 20 calculates a preset pressure and a target flow velocity and rate meeting environmental requirements of the underground mining cavern using a multi-objective optimization algorithm based on received environmental parameters. The environmental parameters are determined by the actual operational requirements of the underground mining cavern and can be adjusted autonomously.

In step S3, the air capturing and pressure stabilizing device 3 captures part of the air output by the air delivery pipe 13 using the kinetic energy of the air discharged by the turbine unit 2, and adjusts the pressure of the captured air according to the preset pressure calculated in step S2 so as to output air under a preset constant pressure.

The air discharged from the air delivery pipe 13 enters the valve seat 23 of the air capturing and pressure stabilizing device 3 under the action of its own kinetic energy. After entering the monitoring chamber of the pressure monitoring assembly 16, the air acts on the diaphragm 34, causing the diaphragm 34 to deform and drive the elastic piece 36 to expand or contract, thereby driving the pressure pointer 37 to be in sliding contact with the contact conductor 38. The intelligent decision-making and coordinated control system 20 is configured to determine the air pressure within the valve seat 23 based on the resistance change of the contact conductor 38, and compare the air pressure within the valve seat 23 with a preset constant pressure value and control the driving mechanism 28 to drive the valve core 25 to move up and down based on a comparison result such that the pressure of air output by the air capturing and pressure stabilizing device 3 is stabilized at the preset constant pressure value.

In step S4, the air purifying device 18 filters and purifies the air output by the air capturing and pressure stabilizing device 3.

The air output from the air capturing and pressure stabilizing device sequentially passes through the multi-stage filter unit, the gas humidity regulation unit, and the ultraviolet sterilization unit. The air is filtered by the multi-stage filter unit to remove particles therefrom, regulated by the gas humidity regulation unit to achieve a humidity level within the comfort range for the underground mining cavern 10, and sterilized by the ultraviolet sterilization unit to remove microorganisms.

In step S5, the flow velocity and rate regulating device 21 adjusts a flow velocity and rate of the air filtered and purified by the air purifying device 18 according to the target flow velocity and rate calculated in step S2, and outputs air with the target flow velocity and rate to the underground mining cavern 10.

The flow velocity and rate of the air output from the lower end of the ball valve housing 43 are detected and compared with the target flow velocity and rate calculated in step S2, i.e., compared with the air velocity and air volume required for air supply in the underground mining cavern 10. When a deviation between the actual flow rate value and the target flow velocity and rate is detected, the opening degree of the flow velocity and rate regulating device 21 is controlled by controlling the servo motor 40 to rotate, such that the final input flow rate into the underground mining cavern 10 is the target flow velocity and rate.

Herein, the involved orientation terms such as “front”, “rear”, “upper”, and “lower” are defined in terms of the positions of parts and between the parts in the drawings, which are used just for clarity and convenience of expressing the technical solution. It should be understood that they are relative concepts and may vary accordingly according to different ways of use and placement, and the use of such parties should not limit the scope of protection of the claimed application.

The above embodiments and the features of the embodiments herein may be combined with each other without conflict. The foregoing are merely preferred embodiments of the present disclosure, and are not intended to limit the present disclosure. Any modifications, equivalent replacements and improvements made within the spirit and principle of the present disclosure should be included in the protection scope of the present disclosure.

What is claimed is:

1. A system for regulating a non-energy-consuming complex environment in a mine based on compressed air energy storage, comprising: a compressed air energy storage power station, an air capturing and pressure stabilizing device, an air purifying device, and a flow velocity and rate regulating device, and an intelligent decision-making and coordinated control system;
wherein the compressed air energy storage power station is constructed in an operating mine that is provided with an underground mining cavern; the compressed air energy storage power station comprises a turbine unit that is provided with an air delivery pipe for discharging air produced by energy release for power generation;
an air inlet of the air capturing and pressure stabilizing device is disposed within the air delivery pipe; the air capturing and pressure stabilizing device comprises a valve seat, a valve core, a pressure monitoring assembly, and a driving mechanism, wherein an air inlet and an air outlet are provided at upper and lower ends of the valve seat, respectively; the air inlet is tapered; the valve core comprises three layers of umbrella-shaped valve discs spaced apart along a vertical direction; the pressure monitoring assembly is arranged inside the valve seat and comprises a monitoring chamber, a diaphragm, an elastic piece, a pressure pointer, and a contact conductor;
the monitoring chamber has an upper portion provided with a detection opening and an interior provided with the diaphragm; the interior of the monitoring chamber is divided by the diaphragm into an upper air cavity and a lower air cavity; the elastic piece is vertically arranged and connected to the diaphragm; the pressure pointer is connected to the elastic piece; the contact conductor is vertically and fixedly arranged on a side of the pressure pointer; the pressure pointer is in vertically sliding contact with the contact conductor such that the pressure pointer and the contact conductor form a sliding rheostat structure; and the driving mechanism is connected to the valve core to drive the valve core to move up and down;
the air purifying device is connected to the air outlet of the valve seat, and comprises a multi-stage filter unit, a gas humidity regulation unit, and an ultraviolet sterilization unit that are connected in sequence;
the flow velocity and rate regulating device is connected to the air purifying device and the underground mining cavern; and
the intelligent decision-making and coordinated control system is connected to the air capturing and pressure stabilizing device, the air purifying device, the flow velocity and rate regulating device, and environmental sensors distributed within pipes and the underground mining cavern, and is configured to: receive a real-time pressure signal from the pressure monitoring assembly, a flow rate feedback value from the flow velocity and rate regulating device, and temperature, humidity, and gas and dust concentration data from the environmental sensors within the underground mining cavern; calculate, using a multi-objective optimization algorithm, a preset pressure and a target flow velocity and rate meeting environmental requirements of the underground mining cavern; and issue execution instructions to the air capturing and pressure stabilizing device, the air purifying device, and the flow velocity and rate regulating device, enabling precise control of the pressure and the flow velocity and rate of air input to the underground mining cavern.

2. The system according to claim 1, wherein the elastic piece is a spring; the contact conductor is arranged in parallel with the spring; the pressure pointer has one end perpendicularly connected to the spring and the other end in sliding contact with the contact conductor; an air pressure change within the monitoring chamber pushes the diaphragm to drive the elastic piece to expand and contract, thereby driving the pressure pointer to produce a vertical sliding displacement relative to the contact conductor, such that the pressure pointer and the contact conductor form the sliding rheostat structure, thereby allowing the real-time pressure signal to be output to the intelligent decision-making and coordinated control system.

3. The system according to claim 1, wherein the driving mechanism is a hydraulic cylinder that is arranged vertically and has a bottom fixed to the air outlet of the valve seat via a holder; and an output end of the hydraulic cylinder is arranged upwards and connected to a lower end of the valve core.

4. The system according to claim 1, wherein flexible sealing rings are disposed at edges of the valve discs; and the three layers of valve discs have gradually increasing diameters from top to bottom, wherein upper two of the three layers of valve discs are configured for contact with and separation from an inner wall of the air inlet to control air introduction, while a lower one of the three layers of valve discs is configured for contact with the inner wall of the air inlet and is sealed by the flexible sealing ring to prevent air backflow.

5. The system according to claim 1, wherein the flow velocity and rate regulating device comprises a ball valve housing, a ball, and a servo motor; upper and lower ends of the ball valve housing are open; the ball is provided with a shaft hole extending therethrough, and is rotatably arranged within the ball valve housing and connected to the servo motor; and the upper end of the ball valve housing is connected to the air purifying device, while the lower end of the ball valve housing is connected to the underground mining cavern.

6. The system according to claim 5, wherein the flow velocity and rate regulating device further comprises a flow velocity and rate sensor that is arranged at the lower end of the ball valve housing; and the intelligent decision-making and coordinated control system is connected to the flow velocity and rate sensor and the servo motor, and is configured to control, according to the flow velocity and rate of air detected by the flow velocity and rate sensor, the servo motor to drive the ball to rotate, thereby adjusting opening degrees of the upper and lower ends of the ball valve housing.

7. The system according to claim 1, wherein the environmental sensors within the underground mining cavern are configured to detect a temperature, a humidity, a gas concentration, and a dust concentration within the underground mining cavern, and feed signals back to the intelligent decision-making and coordinated control system.

8. The system according to claim 1, wherein the compressed air energy storage power station further comprises a wind power generation device, a photovoltaic power generation array, and a compressor unit that are arranged on the ground of the operating mine, and an air storage reservoir that is arranged under the ground of the operating mine; the wind power generation device and the photovoltaic power generation array are connected to the compressor unit to supply power to the compressor unit; the compressor unit is connected to the air storage reservoir such that air is compressed to a predetermined pressure and then stored in the air storage reservoir; and the air storage reservoir is connected to the turbine unit so as to input high-pressure air to the turbine unit such that the turbine unit does work through expansion for power generation, thereby producing air.

9. A method for regulating a non-energy-consuming complex environment in a mine based on compressed air energy storage, applied to the system according to claim 1 and comprising following steps:
S1, outputting air produced by the turbine unit expanding high-pressure air to drive the turbine unit to generate power along the air delivery pipe;
S2, calculating, by the intelligent decision-making and coordinated control system, a preset pressure and a target flow velocity and rate meeting environmental requirements of the underground mining cavern using a multi-objective optimization algorithm based on received environmental parameters;
S3, capturing, by the air capturing and pressure stabilizing device, part of the air output by the air delivery pipe using kinetic energy of the air discharged by the turbine unit, and adjusting a pressure of the captured air according to the preset pressure calculated in step S2 so as to output air under a preset constant pressure;
S4, filtering and purifying, by the air purifying device, the air output by the air capturing and pressure stabilizing device; and
S5, adjusting, by the flow velocity and rate regulating device, a flow velocity and rate of the air filtered and purified by the air purifying device according to the target flow velocity and rate calculated in step S2, and outputting air with the target flow velocity and rate to the underground mining cavern.
